(19) United States
(12) Patent Application Publication
(10) Pub. No.: US 2004/0161110 A1
(43) Pub. Date: Aug. 19, 2004

(54) Server apparatus, key management apparatus, and encrypted communication method

(75) Inventors: Tatsunori Kanai, Kanagawa-ken (JP); Toshibumi Seki, Kanagawa-ken (JP); Hideki Yoshida, Tokyo (JP); Nobuo Sakiyama, Kanagawa-ken (JP)

Correspondence Address: Finnegan, Henderson, Farabow,, Garrett & Dunner, L.L.P., 1300 I Street, N.W., Washington, DC, 20005-3315, US

(73) Assignee: Kabushiki Kaisha Toshiba

(21) Appl. No.: 10/779,659

(22) Filed: Feb. 18, 2004

(30) Foreign Application Priority Data
Feb. 19, 2003 (JP) P2003-41485

(51) Int. Cl. H04L 9/00

(52) U.S. Cl. 380/279

(57) ABSTRACT

Secure communications can be achieved between a server computer and a client computer using a key management apparatus. The key management apparatus maintains a private key for decrypting information from a server or client computer. Data encrypted with a public key is transferred to the key management apparatus for decryption.

### CROSS-REFERENCE TO RELATED APPLICATIONS

This application is based upon and claims the benefit of priority from the prior Japanese Patent Application No. 2003-041485, filed Feb. 19, 2003, the entire contents of which are incorporated herein by reference.

### BACKGROUND

1. Field

The present invention relates to a server apparatus which carries out encrypted communication, a key management apparatus which manages a private key for obtaining a symmetric key which is used in encrypted communication, and an encrypted communication method.

2. Description of Related Art

In order to prevent wiretapping, falsification, etc. of communication content, conventional computer systems, which are connected by a network, such as the Internet or a LAN, communicate using a technology called Secure Sockets Layer (“SSL”). SSL is described in detail in “Internet Encryption Technology—PKI, RSA, SSL, S/MIME. Etc.—” edited by Akira IWATA, written by Haruhiro SUZUKI et al., published by Soft Research Center Inc., ISBN:4-88373-166-9.

SSL is a protocol that provides a secure end-to-end link over which any other application network protocol can operate. SSL can utilize symmetric encryption and asymmetric encryption. Symmetric encryption uses the same key for encrypting and decrypting data. An example of a symmetric encryption protocol is the Data Encryption Standard (“DES”) or the advanced encryption standard (“AES”). Asymmetric encryption or public key encryption uses two different keys (a public key and a private key) to encrypt and decrypt data. The algorithms used in asymmetric encryption employ mathematical hard problems. Thus, although the keys are related, it is not possible to calculate the decryption key from only the encryption key in any reasonable amount of computation time. An example of asymmetric encryption is RSA.

When application programs on two computers are communicating over a network, each application program calls for a communication function, such as TCP/IP, by use of an interface, such as a socket, in order to transmit data. Conventionally, in communication functions, such as TCP/IP, the data transmitted between applications is divided into packets. However, if packets flowing through the network are not encrypted, a risk of wiretapping, falsification, etc. arises. In order to prevent this, an SSL processing unit is interposed between the application program and the communication function. The SSL processing unit encrypts data which is transmitted from the application program and sends the encrypted data out to the network. The SSL processing unit also decrypts encrypted data which is received from the network and passes the decrypted data to the application program.

In one example, an SSL processing unit is implemented in an upper layer of the communication function as a function of the operating system (“OS”). In another example, the SSL processing unit is implemented in the form of a program library so as to be linked with the application program.

Also, the SSL processing unit may be implemented on another computer. For example, communication between a first computer and a second computer may be encrypted using SSL but communication between the second computer and a third computer may not be encrypted. Thus, even though the third computer does not have the SSL processing unit, it is possible to encrypt communication with the first computer, by isolating and protecting a network between the second and third computers. Here, a function of SSL is applied to the second computer, but SSL may be implemented in hardware.

Typical communication using SSL occurs between a client computer and a server computer, such as a WEB browser running on the client computer and a WEB server running on the server computer.

If a large-scale WEB site provides services to a number of users at the same time on the Internet, a plurality of server computers may provide services so that a load is dispersed and fault tolerance is improved. In order to use SSL communications between the users and the server computers, a private key and a certificate must exist which are common to the SSL processing units of all server computers.

However, for security reasons, the private key should not be maintained on the plurality of server computers. That is, if the private key is distributed to the plurality of server computers, the private key may be leaked or stolen when transferred to the server computers. Also, the server computers may be located in remote places and managed by different entities. Thus, the number of people which can access the private key is increased and a risk of leakage of the private key is increased. Furthermore, if additional server computers are used in order to deal with temporary increase of a load, the additional server computers use the private key during the load increase, and the private key may be leaked or stolen from the memory of the additional server.

### SUMMARY

According to one aspect related to the present invention, a server apparatus comprises: a key sharing processing unit for performing a first protocol to share a first key with a client apparatus; an encryption/decryption unit configured to encrypt data or decrypt encrypted data by use of the first key obtained from said key sharing processing unit; a communication unit configured to transmit to said client apparatus, data which was encrypted by said encryption/decryption unit or receive from said client apparatus, data which was encrypted using the first key. The key sharing processing unit has: a first reception unit configured to receive key information from said client apparatus, said key information including the first key or data which becomes a basis for generating the first key, and said key information being encrypted with a second key, a transmission unit configured to transmit a request to decrypt the key information to a key management apparatus which maintains a third key necessary for decrypting the key information; and a second reception unit configured to receive the first key or the data which becomes a basis for generating the first key from said key management apparatus.

According to another aspect related to the present invention, a key management apparatus comprises: a reception unit configured to receive a request for decrypting key information from a server apparatus, said key information including a first key or data which becomes a basis for generating the first key, and said key information being encrypted with a second key; a storing unit configured to store a third key which is necessary for decrypting the key information; a decryption unit configured to decrypt the key information with the third key and obtain the first key or the data which becomes a basis for generating the first key, after receiving the request; and a transmission unit configured to transmit to said server apparatus the first key or the data which becomes a basis for generating the first key, wherein said server apparatus and a client apparatus are able to share the first key.

According to another aspect related to the present invention, an encrypted communication method comprises: receiving key information from a client apparatus, said key information including a first key or data which becomes a basis for generating the first key, and said key information being encrypted with a second key; transmitting a request to decrypt the key information to a key management apparatus which stores a third key necessary for decrypting the key information; receiving the first key or the data which becomes a basis for generating the first key from said key management apparatus; if the key information is a basis for generating the first key, generating the first key from the basis; and encrypting data using the first key and transmitting the data encrypted with the first key to said client apparatus, or receiving data encrypted with the first key from said client apparatus and decrypting the data encrypted with the first key.

According to another aspect related to the present invention, an encrypted communication method comprises: receiving a request for decrypting key information from a server apparatus, said key information including a first key or data which becomes a basis for generating the first key, and said key information being encrypted with a second key; storing a third key which is necessary for decrypting the key information; decrypting said key information with the third key and obtaining the first key or the data which becomes a basis for generating the first key, after receiving the request; and transmitting to said server apparatus the first key or the data which becomes a basis for generating the first key, wherein the server apparatus and a client apparatus are able to share the first key.

According to another aspect related to the present invention, communication program for communicating to a client computer, comprises: a key sharing processing program code configured to carry out a protocol for sharing a first key with a client computer; an encryption/decryption program code configured to encrypt data or decrypt encrypted data using of first key obtained from said key sharing processing program code; and a communication program code configured to transmit to said client apparatus, data encrypted by said encryption/decryption program code or configured to receive, from said client apparatus, data which was encrypted using the first key. The key sharing processing program code has: a first reception program code configured to receive key information from said client apparatus, said key information including the first key or data which becomes a basis for generating the first key, and said key information being encrypted with a second key; a transmission program code configured to transmit a request to decrypt the key information to a key management apparatus which stores a third key necessary for decrypting the key information; and a second reception program code configured to receive the first key or the data which becomes a basis for generating the first key from said key management apparatus.

According to another aspect related to the present invention, a communication program for managing key information, comprises: a first reception program code configured to receive a request for decrypting key information from a server apparatus, said key information including a first key or data which becomes a basis for generating the first key, and said key information being encrypted with a second key; a first storing program code configured to store a third key necessary for decrypting the key information; a decryption program code configured to decrypt said key information with the third key and obtain the first key or the data which becomes a basis for generating the first key, after receiving the request; and a first transmission program code configured to transmit the first key or the data which becomes a basis for generating the first key to said server apparatus, wherein said server apparatus and a client apparatus are capable of sharing the first key.

According to another aspect related to the present invention, a secure communication system, comprises: a network; a server apparatus connected to said network and capable of exchanging data with a client apparatus, said server apparatus having a certificate which includes a public key; a client apparatus connected to said network, and capable of exchanging data with said server apparatus and receiving said certificate from the said server apparatus; and a key management apparatus connected to said network. The key management apparatus includes: a first reception unit configured to receive a request for decrypting key information from the server apparatus, said key information including a first key or data which becomes a basis for generating the first key, and said key information being encrypted with the public key by said client apparatus; a first storing unit configured to store a private key which is necessary for decrypting the key information; a decryption unit configured to decrypt the key information with the third key and obtain the first key or the data which becomes a basis for generating the first key, after receiving the request; and a first transmission unit configured to transmit to said server apparatus the first key or the data which becomes a basis for generating the first key.

Additional advantages of the invention will be set forth in part in the description which follows, and in part will be obvious from the description, or may be learned by practice of the invention. The advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several aspects of the invention and together with the description, serve to explain the principles of the invention.

FIG. 1 is a diagram illustrating a communication system 100 consistent with one aspect related to the present invention;

FIG. 2 is a diagram illustrating the processing of the communication system illustrated in FIG. 1 consistent with one aspect related to the present invention;

FIG. 3 is a diagram illustrating a communication system 300 consistent with one aspect related to the present invention; and

FIG. 4 is a diagram of a communication system 400 consistent with one aspect related to the present invention.

### DETAILED DESCRIPTION

Reference will now be made in detail to various aspects related to the present invention, examples of which are illustrated in the accompanying drawings. Wherever possible, the same reference numbers will be used throughout the drawings to refer to the same or like parts.

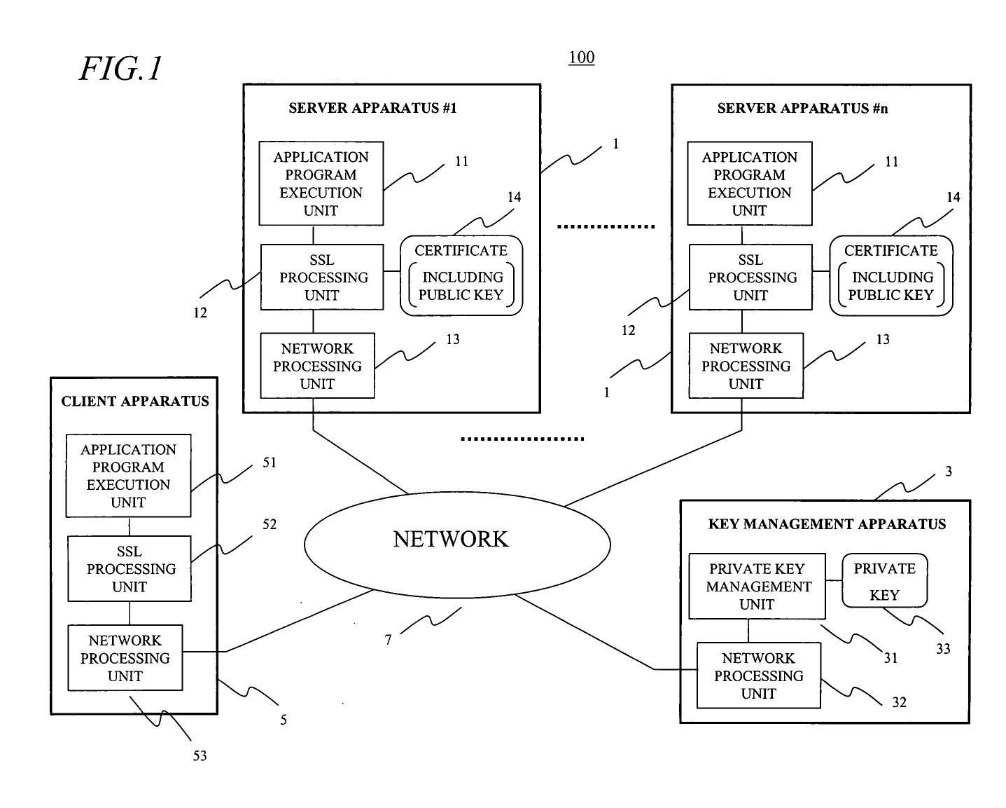

FIG. 1 illustrates a communication system 100 consistent with one aspect related to the present invention. Communication system 100 may include a plurality of server apparatuses 1, a key management apparatus 3, and a client apparatus 5, all of which are designed to be able to be connected to a network 7.

Network 7 may be the Internet, a virtual private network, a local area network, a wide area network, a broadband digital network, or any other structure for enabling communication between two or more nodes or locations. Network 7 may include a shared, public, or private data network and encompass a wide area or local area. Network 7 may include one or more wired and/or wireless connections. Network 7 may employ communication protocols, such as Transmission Control and Internet Protocol (TCP/IP), Asynchronous Transfer Mode (ATM), Ethernet, or any other compilation of procedures for controlling communications among network locations. Network 7 may also include and/or provide telephone services. Network 7 may be included and/or leverage a Public Switched Telephone Network (“PSTN”).

Each server apparatus 1 may include an application program execution unit 11 for executing an application program, an SSL processing unit 12 for carrying out SSL processing, such as a procedure for sharing a key and encryption of data to be transmitted and decryption of encrypted data which is received, a network processing unit 13 for carrying out network processing, such as TCP/IP processing, and a certificate storage unit 14 for storing a certificate including a public key. In addition, certificate storage unit 14 may be included in SSL processing unit 12.

Key management apparatus 3 may include a private key management unit 31 for carrying out management of a private key, a network processing unit 32 for carrying out network processing, such as TCP/IP processing, and a private key storage unit 33 for storing the private key. In addition, private key storage unit 33 may be included in private key management unit 31. Key management apparatus 3 manages the private key, such that each server apparatus 1 using SSL does not maintain the private key.

Client apparatus 5 may include an application program execution unit 51 for executing an application program, an SSL processing unit 52 for carrying out SSL processing, and a network processing unit 53 for carrying out network processing, such as TCP/IP processing.

Server apparatus 1 functions essentially the same as a conventional server apparatus, but unlike conventional server apparatus, server apparatus 1 does not hold or manage the private key. Instead, server apparatus 1 may request encryption processing based on the private key from key management apparatus 3 which manages the private key. Accordingly, key management apparatus 3 may accept a request from server apparatus 1, perform encryption processing based on the private key, and return the result to server apparatus 1.

Communication system 100, as illustrated in FIG. 1, includes two server apparatuses 1, but communication system 100 is not limited to two server apparatuses. Communication system 100 may include any number of server apparatuses, greater than or less than two, necessary to facilitate communications. Also, communication system 100, as illustrated in FIG. 1, includes one client apparatus 5, but communication system 100 is not limited to one client apparatus 5. Communication system 100 may include any number of client apparatuses 5.

Aspects of the invention will be described for an exemplary communication system which includes one key management apparatus 3. All server apparatuses 1 request encryption processing based on the private key from key management apparatus 3, and key management apparatus 3 uses a single common private key for the plurality of server apparatuses 1. However, communication system 100 may include multiple key management apparatuses and utilize multiple private keys.

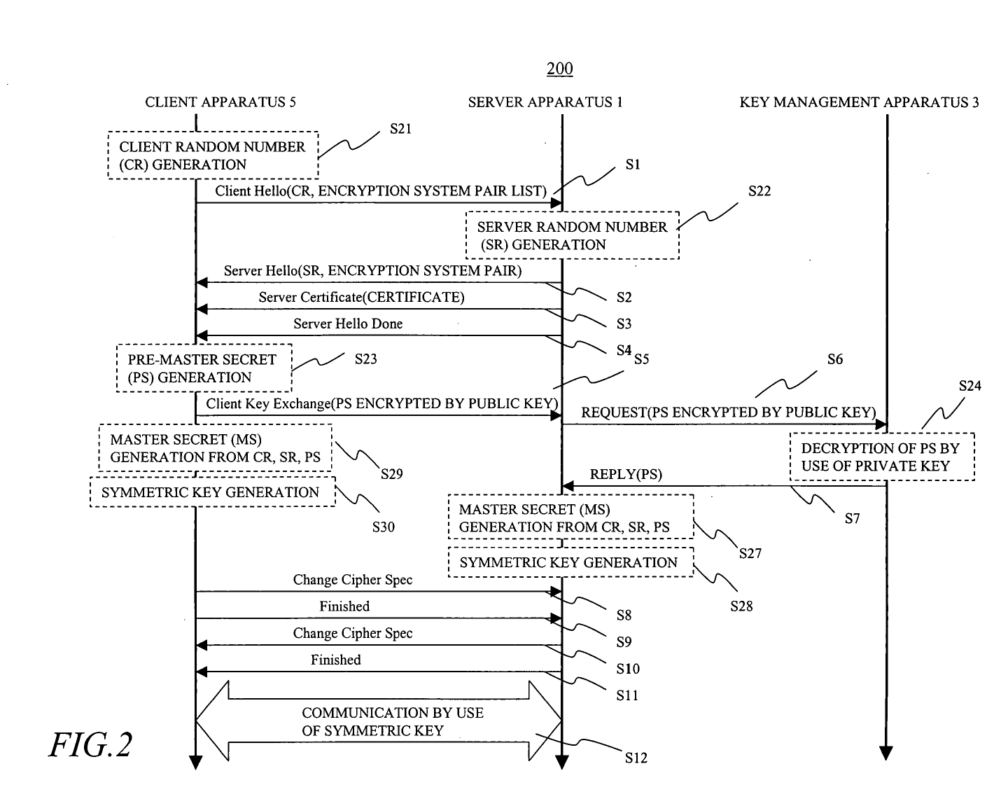

FIG. 2 illustrates one example of procedures which are carried out in order for client apparatus 5 and server apparatus 1 in FIG. 1 to start data communication using SSL consistent with one aspect related to the present invention. Server apparatus 1 may be any of server apparatuses 1 (#1 . . . #n). FIG. 2 illustrates a process 200 between client apparatus 5 and server apparatus 1 (e.g., between SSL processing units 12, 52), and between server apparatus 1 and key management apparatus 3 (e.g., between SSL processing unit 12 and private key management unit 31).

First, client apparatus 5 generates a client random number (“CR”) which becomes a part of a seed for generating a symmetric key. The symmetric key may be later used for data communications (stage S21).

Next, client apparatus 5 adds the generated CR and an acceptable encryption system pair list to a ClientHello message, and transmits the ClientHello message to server apparatus 1 (stage S1). The encryption system pair list describes which one or a plurality of pairs of an encryption processes may be used for key exchange and an encryption process which may used for data communication. The encryption process may be any known symmetric or asymmetric encryption process, for example, DES, AES, RSA public key, or El-Gamal.

Once server apparatus 1 receives the ClientHello message, server apparatus 1 generates a server random number (“SR”) which will also become part of the seed for generating the symmetric key used for data communications (stage S22). Also, server apparatus 1 selects a pair of encryption processes which are used for key exchange and data communication out of the encryption process pair list which was transmitted from the client apparatus 5. Then, server apparatus 1 adds the generated SR and the selected encryption process pair to a ServerHello message, and transmits the ServerHello message to client apparatus 5 (stage S2). Subsequently, server apparatus 1 adds a certificate 14, which is maintained at server apparatus 1, to a ServerCertificate message, and transmits the ServerCertificate message to client apparatus 5 (stage S3).

Certificate 14 may include the standard information about server apparatus 1, such as name and network address, plus the public key and server apparatus 1 digital signature establishing the authenticity of the certificate. Certificate 14 may include information about key management system 5, such as name and network address. Certificate 14 may be arranged in any standard format, such as X.509.

Then, server apparatus 1 transmits a ServerHelloDone message to client apparatus 5 (stage S4). The ServerHelloDone message informs client apparatus 5 that server apparatus 1 has finished transmitting Hello messages.

After client apparatus 5 receives, from server apparatus 1, the ServerHello message (stage S2), the ServerCertificate message (stage S3), and the ServerHelloDone message (stage S4), client apparatus 5 generates a random number called a pre-master secret (“PS”), which will also become part of the seed for generating the symmetric key used for data communication (stage S23).

Subsequently, client apparatus 5 encrypts the generated PS with the public key which is included in certificate 14, and adds the encrypted PS to a ClientKeyExchange message. Client apparatus 5 then transmits the ClientKeyExchange message to server apparatus 1 (stage S5).

Although the private key is required for decrypting PS, server apparatus 1 does not have the private key corresponding to the public key used to encrypt PS and, therefore, server apparatus 1 can not decrypt PS. Accordingly, server apparatus 1 requests key management apparatus 3 to decrypt PS using the private key corresponding to the public key contained in certificate 14. When server apparatus 1 receives the ClientKeyExchange message from client apparatus 5, server apparatus 1 adds the encrypted PS from the ClientKeyExchange message to a decryption Request message, and transmits the decryption Request message to key management apparatus 3 (stage S6).

Once the decryption Request message is received, key management apparatus 3 locates the private key, which is stored in private key storage unit 33, corresponding to the public key and decrypts the encrypted PS using the private key (stage S24). Then, key management apparatus 3 adds the decrypted PS to a Reply message to the decryption request message, and transmits the Reply message to server apparatus 1 (stage S7).

After receiving the decrypted PS, server apparatus 1 calculates a value called a master secret (“MS”) by using one of the three random numbers CR, SR, and PS as seeds to generate MS (stage S27). Then, in accordance with the encryption procedure specified in stage S2, server apparatus 1 makes a sequence of numbers called a key block by using MS as a seed and, from the key block, generates a symmetric key for data communication with client apparatus 5 (stage S28).

Meanwhile, client apparatus 5 calculates MS by using the three random numbers, CR, SR and PS as seeds, in the same manner as server apparatus 1 (stage S29). Client apparatus 5 may generate MS at any time after generating PS since CR and SR were generated (stage S21) and received (stage S2), respectively, prior to generating PS. Preferably, PS would be generated immediately after transmitting the ClientKeyExchange message in order to avoid communications delays with server apparatus 1. Then, in accordance with the encryption procedure specified in stage S2, client apparatus 5 makes a key block by using MS as a seed and, on the basis of the key block, generates the symmetric key which is necessary for data communication server 1 (stage S30).

Once finished generating the symmetric key, client apparatus 5, sequentially transmits a ChangeCipherSpec message (stage S8) and a Finished message (stage S9) to server apparatus 1. Likewise, once finished generating the symmetric key, server apparatus 1 sequentially transmits a ChangeCipherSpec message (stage S10) and a Finished message (stage S11) to client apparatus 5. Once both Finished messages are received, the establishment phase for SSL data communications is complete.

After this, client apparatus 5 and server apparatus 1 may carry out secure communication using the encryption system determined and transmitted as the encryption system pair in the stage S2 and the symmetric key generated in stages S28/S30 (stage S12).

In the exemplary description above, authentication is carried out for server apparatus 1 only, but a similar procedure may be used to authenticate client apparatus 5 if client apparatus 5 has a private key and a certificate. For example, authentication of client apparatus 5 may be the same as in conventional communication systems or authentication of client apparatus 5 may be achieved using a key management apparatus 3 in a similar manner as described above for the authentication of server apparatus 1.

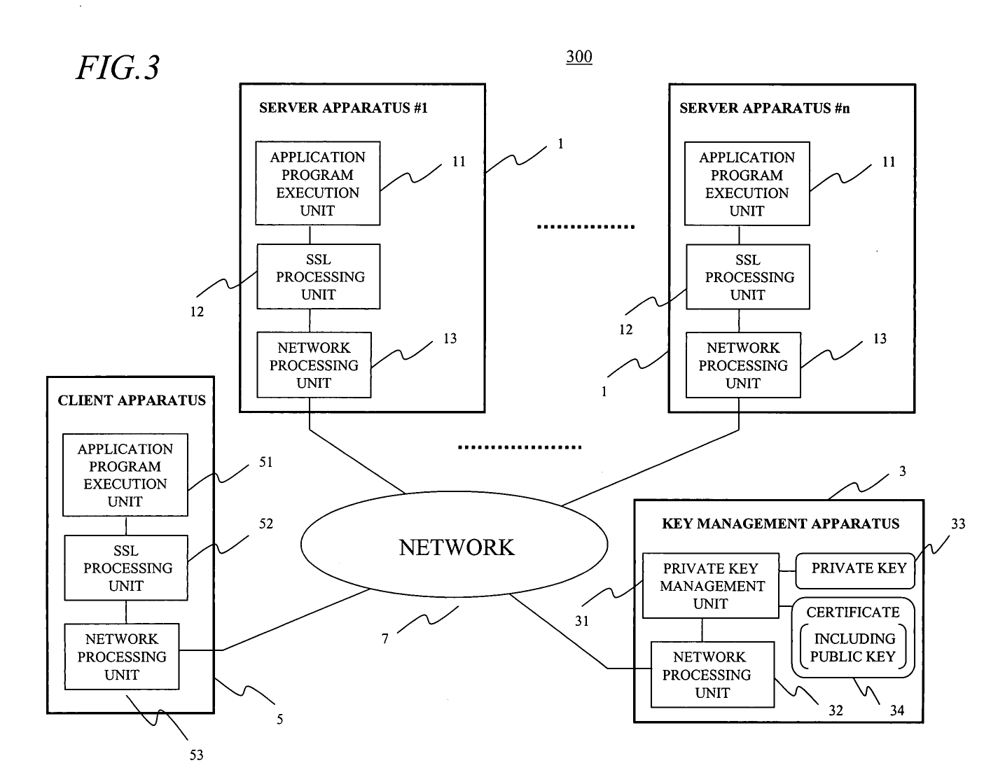

Also, in the exemplary description above, all server apparatuses 1 have a certificate, but each server apparatus 1 and key management apparatus 3 may maintain a certificate. Alternately, as illustrated in FIG. 3, a communication system 300 may include a key management apparatus 3 which maintains a certificate in certificate storage unit 34. For example, key management apparatus 3 and a portion of server apparatuses 1 may maintain certificates, and a server apparatus 1 which does not have a certificate obtains it from key management apparatus 3 each time a certificate is needed.

Further, server apparatus 1 may not obtain the certificate from key management apparatus 3 every time that the certificate is needed, but server apparatus 1 may cache and repeatedly use the certificate which was obtained from key management apparatus 3 at an earlier time. For example, server apparatus 3 may obtain a certificate the first time a valid certificate is needed at server apparatus 3, and server apparatus 3 may obtain a new certificate once a cached certificate expires.

Also, in the exemplary description above, only one key management apparatus 3 is included in communications systems 100 or 300, and all server apparatuses 1 request encryption processing with the private key from key management apparatus 3, and key management apparatus 3 uses a single private key which is common to all server apparatuses 1. Alternatively, communications systems 100 and 300 may include a plurality of key management apparatuses 3, and each server apparatus 1 may request encryption processing with a private key for any one of the plurality of key management apparatuses 3. In this example, all key management apparatuses 3 may maintain a single private key which is common to all server apparatuses 1 which all key management apparatuses 3 are supporting, or a single private key which is unique to each key management apparatus 3 or server apparatus 1.

Further, communication systems 100 and 300 may include a plurality of key management apparatuses 3, and each server apparatus 1 may request encryption processing with a private key from a predetermined number of the plurality of key management apparatuses 3. Server apparatus 1, which receives encryption processing from the plurality of key management apparatuses 3 may select any one of key management apparatuses 3, for example, at the time of request, and carries out the request. The plurality of key management apparatuses 3 may use a single private key which is common to all of the server apparatuses 1 which all key management apparatuses 3 are supporting, or a single private key which is unique to each key management apparatus 3 or server apparatus 1.

Alternatively, communications systems 100 and 300 may include key management apparatus 3, which maintains a specific private key for each server apparatus 1. When key management apparatus 3 receives a request from server apparatus 1, key management apparatus 3 uses a private key which corresponds to the requesting server apparatus 1 in the encryption processing.

By disposing a plurality of key management apparatuses 3 for each server apparatus 1, it is possible to reduce a load of only one key management apparatus 3 and reduce failure. By disposing the plurality of key management apparatuses 3 for multiplexing, it is possible to heighten fault tolerance.

Also, each server apparatus 1 may include components for carrying out SSL without support of key management apparatus 3 by having a private key (e.g., unique private key which is different from a private key which is managed by key management apparatus 3). Further, each server apparatus 1 may carry out SSL processing with support of key management apparatus 3 and carry out SSL processing without support of key management apparatus 3 by having a private key (e.g., unique private key which is different from a private key which is managed by key management apparatus 3).

Additionally, communication between server apparatus 1 and key management apparatus 3 may be secured so that the PS is not stolen by monitoring the communication between server apparatus 1 and key management apparatus 3. In order to prevent this, various encryption methods may be used to protect the communication between server apparatus 1 and key management apparatus 3. For example, network 7 may include a dedicated network between server apparatus 1 and key management apparatus 3, which is isolated from other systems, such as client apparatus 5.

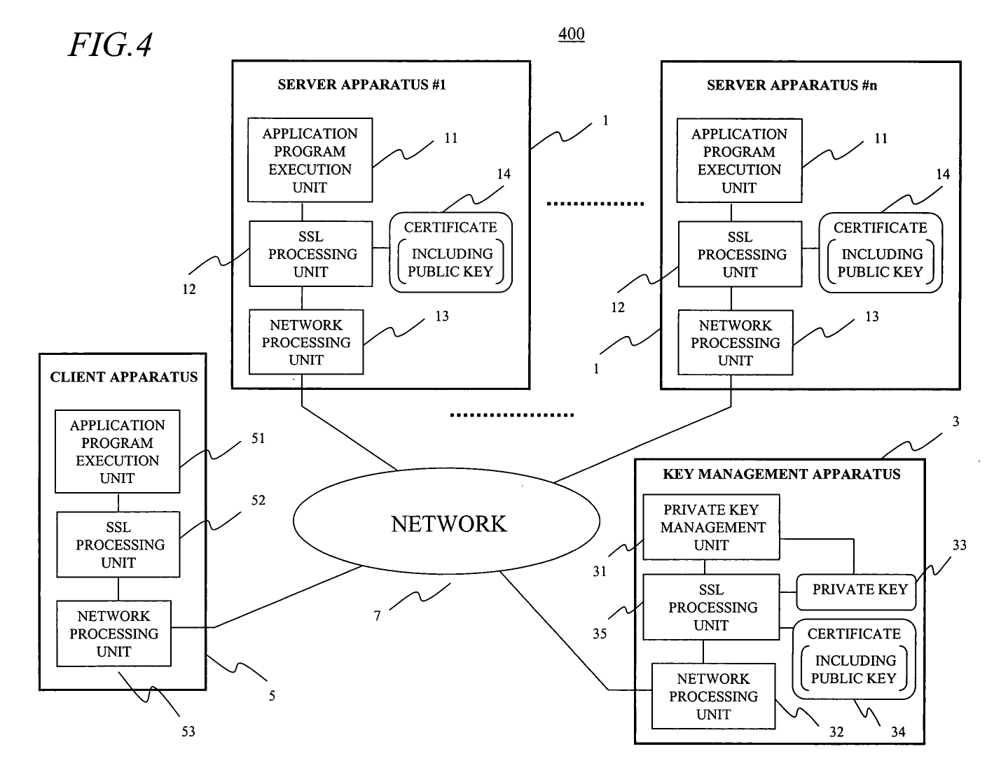

Further, FIG. 4 illustrates a communication system 400 for protecting communication with key management apparatus 3 by including an SSL processing unit 35 consistent with one aspect related to the present invention. Accordingly, communication between server apparatus 1 and key management apparatus 3 may use SSL, in order to protect communication of the decryption request message including encrypted PS and communication of the response message including decrypted PS. In this case, communications between the server apparatus 1 and key management apparatus 3 can be carried out in the same manner as communication between client apparatus 3 and server apparatus 1 using SSL as illustrated in FIG. 2. Further, if network 7 between server apparatus 1 and key management apparatus 3 includes a dedicated network isolated from other systems, communication between server apparatus 1 and key management apparatus 3 may be carried out in the same manner as communication between client apparatus 5 and server apparatus 1 using SSL as illustrated in FIG. 2.

Furthermore, in communications system 400 as illustrated in FIG. 4, the same private keys, private key A and private key B, may be used in SSL data communication between the client apparatus 5 and the server apparatus 1 (i.e., key which is used for decryption of PS encrypted by client apparatus 5) and in SSL communication between server apparatus 1 and key management apparatus 3 (i.e., key which is used for decryption of PS encrypted by server apparatus 1), respectively.

Alternatively, a private key A may be used in SSL data communication between the client apparatus 5 and the server apparatus 1 (i.e., key which is used for decryption of PS encrypted by client apparatus 5) and in SSL communication between server apparatus 1 and key management apparatus 3 (i.e., key which is used for decryption of PS encrypted by server apparatus 1), but the private key B, different from private key A, may be used in SSL communication between server apparatus 1 and key management apparatus 3 (i.e., key which is used for decryption of PS encrypted by server apparatus 1). Also, if a private key A is disposed with respect to each server apparatus 1, a private key B may be different from any of the private key A, or a private key B may coincide with any of the private key A.

Also, if a plurality of key management apparatuses 3 are included in communication systems 100, 300, and 400, key management apparatus 3 communicating with server apparatus 1 using the SSL process may request decryption processes from another key management apparatus. For example, key management apparatus 3 may not maintain a private key B and may be used in SSL communication between server apparatus 1 and key management apparatus 3, but private key B may be maintained on an additional key management apparatus (not shown). Thus, key management apparatus 3 may request encryption processing from the additional key management apparatus using any of the exemplary processes described above.

Further, an additional key management apparatus (not shown) may be included in any of the communication systems 100, 300, and 400 to maintain a private key A and may be used in SSL data communication between the client apparatus 5 and the server apparatus 1. For example, when key management apparatus 3 receives a decryption request message from server apparatus 1, key management apparatus 3 may transmit the decryption request message to a key management apparatus (not shown). The additional key management apparatus decrypts PS, and returns the response message including decrypted PS to key management apparatus 3. Subsequently, key management apparatus 3 returns the response message including PS to server apparatus 1.

In communication systems 100, 300, and 400 illustrated in FIGS. 1, 3, and 4, communication between client apparatus 5 and server apparatus 1 may be a WEB browser on client apparatus 5 and a WEB server on server apparatus 1, but communication is not limited to WEB services. Client apparatus 5 and server apparatus 1 may execute any application program which communicates over network 4. Further, communication systems 100, 300, and 400 are not limited to communications between client apparatus 5 and server apparatus 1. Communications may be carried out with any system connected to network 5 using the exemplary process described above. Further, communications systems 100, 300, and 400 are not limited to client and server apparatuses. Communication systems 100, 300, and 400 may include any communications device, for example, a terminal apparatus or portable telephone.

Also, the plurality of apparatuses and systems which carry out the SSL process may be included in dedicated hardware called an SSL accelerator, in order to manage private keys by key management apparatus 3 in an integrated fashion, without distributing private keys to respective apparatuses or SSL accelerators.

Communications systems 100, 300, and 400 have been described for communications where server apparatus 1 includes a certificate and a private key, but client apparatus 5 may also include a certificate and a private key to carry out client authentication. Also, exemplary process 200 illustrated in FIG. 2 may be reversed such that client apparatus 5 generates a symmetric key, and transfers the symmetric key which was encrypted by a public key from the client apparatus 5 to the server apparatus 1.

FIGS. 1, 3, and 4 illustrate that server apparatus 1, client apparatus 5, and key management apparatus 3 include certain components. However, server apparatus 1, client apparatus 5, and key management apparatus 3 are not limited to these components. Server apparatus 1, client apparatus 5, and key management apparatus 3 may contain the standard components required for inputting, outputting, manipulating, and storing data. For example, server apparatus 1, client apparatus 5, and key management apparatus 3 may also include any of a central processing unit (CPU), random access memory (RAM), video card, sound card, magnetic storage devices, optical storage devices, input/output (I/O) terminals, and a network interface card (NIC). Server apparatus 1, client apparatus 5, and key management apparatus 3 can optionally be connected to input and output devices, such as keyboards and printers through their I/O terminals. Examples of the I/O terminals are parallel, serial, universal serial bus, and IEEE 1394.

Also, exemplary communication systems 100, 300 and 400 utilize SSL, but may also utilize other protocols, such as Transport Layer Security (“TSL”).

Any of the units, components, and processes included in and performed by client apparatus 5, server apparatus 1, and key management 3 may be implemented in hardware or software. For example, client apparatus 5, server apparatus 1, and key management 3 may include computer readable media which has instructions to cause the apparatus to perform the exemplary process described above. Furthermore, client apparatus 5, server apparatus 1, and key management 3 may include the hardware or software to create and record the computer readable media.

In the exemplary systems and processes described above, the server apparatus is not required to maintain the private key using an encryption process. Accordingly, the private key cannot be leaked from the server apparatus itself. Also, since there is no distribution route of the private key to the server apparatus, the private key will not be leaked in the distribution route. Also, since the private key is not maintained on the server apparatuses, access to the private key is limited and risk of leaking the private key is reduced.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A server apparatus comprising:
a key sharing processing unit configured to perform a first protocol to share a first key with a client apparatus;
an encryption/decryption unit configured to encrypt data or decrypt encrypted data by use of the first key obtained from said key sharing processing unit;
a communication unit configured to transmit to said client apparatus, data which was encrypted by said encryption/decryption unit or receive from said client apparatus, data which was encrypted by using the first key; and
said key sharing processing unit having:
a first reception unit configured to receive key information from said client apparatus, said key information including the first key or data which becomes a basis for generating the first key, and said key information being encrypted with a second key,
a transmission unit configured to transmit a request to decrypt the key information to a key management apparatus which maintains a third key necessary for decrypting the key information; and
a second reception unit configured to receive the first key or the data which becomes a basis for generating the first key from said key management apparatus.

2. The server apparatus according to claim 1, further comprising a key generation unit configured to generate the first key, from the data which becomes a basis for generating the first key.

3. The server apparatus according to claim 1, wherein a connection between said server apparatus and said key management apparatus is through a dedicated network isolated from said client apparatus.

4. The server apparatus according to claim 1, wherein data transferred to said key management apparatus is encrypted before transfer.

5. The server apparatus according to claim 4, wherein a second protocol for sharing a fourth key which is used for encrypting data transferred to said key management apparatus is as same as the first protocol.

6. The server apparatus according to claim 1, wherein said transmission unit transmits all requests to one predetermined key management apparatus.

7. The server apparatus according to claim 1, wherein said transmission unit transmits the request to one predetermined key management apparatus selected from a plurality of key management apparatuses.

8. The server apparatus according to claim 1, further comprising a storing unit configured to store authentication information used to authenticate said server apparatus with said client apparatus.

9. The server apparatus according to claim 1, further comprising an obtaining unit configured to obtain authentication information used for server authentication with said client apparatus from said key management apparatus.

10. The server apparatus according to claim 1, wherein the server apparatus stores the second key temporarily, but does not stores the third key at any time.

11. A key management apparatus comprising:
a reception unit configured to receive a request for decrypting key information from a server apparatus, said key information including a first key or data which becomes a basis for generating the first key, and said key information being encrypted with a second key;
a storing unit configured to store a third key which is necessary for decrypting the key information;
a decryption unit configured to decrypt the key information with the third key and obtain the first key or the data which becomes a basis for generating the first key, after receiving the request; and
a transmission unit configured to transmit to said server apparatus the first key or the data which becomes a basis for generating the first key,
wherein said server apparatus and a client apparatus are able to share the first key.

12. The key management apparatus according to claim 11, wherein said key information is encrypted by said client apparatus.

13. The key management apparatus according to claim 11, wherein a connection between said key management apparatus and said server apparatus is through a dedicated network which is isolated from said client apparatus.

14. The key management apparatus according to claim 11, wherein data to be transferred to said server apparatus is encrypted before transfer.

15. The key management apparatus according to claim 14, wherein a protocol for sharing a fourth key used to encrypt data transferred to said server apparatus is the same as a protocol for sharing said first key between said server apparatus and said client apparatus.

16. The key management apparatus according to claim 11, wherein the key management apparatus is connected to a plurality of server apparatuses, and the second key and the third key are commonly used for the plurality of server apparatuses.

17. The key management apparatus according to claim 11, wherein the key management apparatus is connected to a plurality of server apparatuses, and the second key and the third key are unique to one server apparatus of the plurality of server apparatus.

18. The key management apparatus according to claim 11, further comprising:
a second storing unit configured to store authentication information which said server apparatus uses for server authentication with said client apparatus;
a second reception unit configured to receive, from said server apparatus, an authentication request for the authentication information; and
a second transmission unit configured to transmit the authentication information to said server apparatus, after receiving the authentication request.

19. An encrypted communication method comprising:
receiving key information from a client apparatus, said key information including a first key or data which becomes a basis for generating the first key, and said key information being encrypted with a second key;
transmitting a request to decrypt the key information to a key management apparatus which stores a third key necessary for decrypting the key information;
receiving the first key or the data which becomes a basis for generating the first key from said key management apparatus;
if the key information is a basis for generating the first key, generating the first key from the basis; and
encrypting data using the first key and transmitting the data encrypted with the first key to said client apparatus, or receiving data encrypted with the first key from said client apparatus and decrypting the data encrypted with the first key.

20. The encrypted communication method according to claim 19, wherein
encrypting said key information comprises using an asymmetric encryption process, and
the second key is a public key and the third key is a private key.

21. An encrypted communication method comprising:
receiving a request for decrypting key information from a server apparatus, said key information including a first key or data which becomes a basis for generating the first key, and said key information being encrypted with a second key;
storing a third key which is necessary for decrypting the key information;
decrypting said key information with the third key and obtaining the first key or the data which becomes a basis for generating the first key, after receiving the request; and
transmitting to said server apparatus the first key or the data which becomes a basis for generating the first key,
wherein the server apparatus and a client apparatus are able to share the first key.

22. The encrypted communication method according to claim 21, wherein
decrypting said key information comprises using an asymmetric decryption process, and
the second key is a public key and the third key is a private key.

23. A communication program for communicating to a client computer, comprising:
a key sharing processing program code configured to perform a protocol for sharing a first key with a client computer;
an encryption/decryption program code configured to encrypt data or decrypt encrypted data using of first key obtained from said key sharing processing program code;
a communication program code configured to transmit to said client apparatus, data encrypted by said encryption/decryption program code or configured to receive, from said client apparatus, data which was encrypted using the first key; and
said key sharing processing program code having:
a first reception program code configured to receive key information from said client apparatus, said key information including the first key or data which becomes a basis for generating the first key, and said key information being encrypted with a second key;
a transmission program code configured to transmit a request to decrypt the key information to a key management apparatus which stores a third key necessary for decrypting the key information; and
a second reception program code configured to receive the first key or the data which becomes a basis for generating the first key from said key management apparatus.

24. A communication program for managing key information, comprising:
a first reception program code configured to receive a request for decrypting key information from a server apparatus, said key information including a first key or data which becomes a basis for generating the first key, and said key information being encrypted with a second key;
a first storing program code configured to store a third key necessary for decrypting the key information;
a decryption program code configured to decrypt said key information with the third key and obtain the first key or the data which becomes a basis for generating the first key, after receiving the request; and
a first transmission program code configured to transmit the first key or the data which becomes a basis for generating the first key to said server apparatus,
wherein said server apparatus and a client apparatus are capable of sharing the first key.

25. A secure communication system, comprising:
a network;
a server apparatus connected to said network and capable of exchanging data with a client apparatus, said server apparatus having a certificate which includes a public key;
a client apparatus connected to said network, and capable of exchanging data with said server apparatus and receiving said certificate from said server apparatus;
a key management apparatus connected to said network, said key management apparatus including:
a first reception unit configured to receive a request for decrypting key information from said server apparatus, said key information including a first key or data which becomes a basis for generating the first key, and said key information being encrypted with the public key by said client apparatus;
a first storing unit configured to store a private key which is necessary for decrypting the key information;
a decryption unit configured to decrypt the key information with the private key and obtain the first key or the data which becomes a basis for generating the first key, after receiving the request; and
a first transmission unit configured to transmit to said server apparatus the first key or the data which becomes a basis for generating the first key.
